(19) United States
(12) Patent Application Publication
(10) Pub. No.: US 2023/0100061 A1
(43) Pub. Date: Mar. 30, 2023

(54) Parking Practice Assembly

(71) Applicant: Otis Morris, St. Cloud, MN (US)

(72) Inventor: Otis Morris, St. Cloud, MN (US)

(21) Appl. No.: 17/487,844

(22) Filed: Sep. 28, 2021

(51) Int. Cl. G09B 19/16

(52) U.S. Cl. CPC G09B 19/167

(57) ABSTRACT

A parking practice assembly for practicing parking a vehicle includes a first corner post, a second corner post and a third corner post. A short cable is attachable between the first corner post and the second corner post. The short cable has a length of at least 185.0 inches to space the corner posts a distance apart from each other that corresponds to the width and a length of a parking space for a vehicle. A long cable is attachable between second corner post and the third corner post such that the long cable is oriented perpendicular to the short cable. Additionally, the long cable has a length of at least 372.0 inches to space the corner posts a distance apart from each other that corresponds to the width and the length of the parking space for the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to parking devices and more particularly pertains to a new parking device for practicing parking a vehicle. The device includes a plurality of telescopic corner poles that can each be vertically oriented on a driving surface. A short cable is attachable between a respective pair of the corner posts and a long cable is attachable between a respective pair of the corner posts. The long cable is oriented perpendicular to the short cable to define a parking space into which a vehicle can be driven for practicing parking.

### (2) Description of Related Art Including Information Disclosed Under 37 CFR 1.97 and 1.98

The prior art relates to parking devices including a telescopic road sign device. The prior art discloses a parking guide device that displays a video image of a parking area into which a vehicle is driving. The prior art discloses a parking guidance device which includes an electronic beacon for monitoring parking spaces in a parking area.

### BRIEF SUMMARY OF THE INVENTION

An embodiment of the disclosure meets the needs presented above by generally comprising a first corner post, a second corner post and a third corner post. A short cable is attachable between the first corner post and the second corner post. The short cable has a length of at least 185.0 inches to space the corner posts a distance apart from each other that corresponds to the width and a length of a parking space for a vehicle. A long cable is attachable between second corner post and the third corner post such that the long cable is oriented perpendicular to the short cable. Additionally, the long cable has a length of at least 372.0 inches to space the corner posts a distance apart from each other that corresponds to the width and the length of the parking space for the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a corner post of a parking practice assembly according to an embodiment of the disclosure.

FIG. 2 is a front phantom view of an embodiment of the disclosure.

FIG. 3 is a perspective view of an embodiment of the disclosure.

FIG. 4 is a perspective in-use view of a short cable of an embodiment of the disclosure.

FIG. 5 is a perspective in-use view of a long cable of an embodiment of the disclosure.

FIG. 6 is a perspective in-use view of an embodiment of the disclosure showing a vehicle being parked in a parking space.

### DETAILED DESCRIPTION OF THE INVENTION

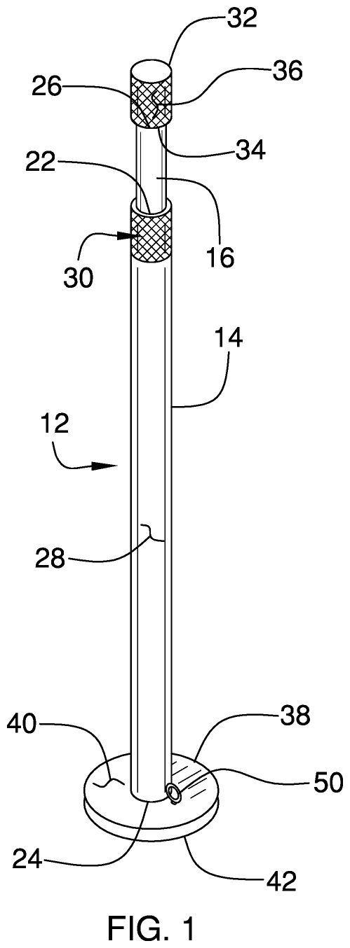

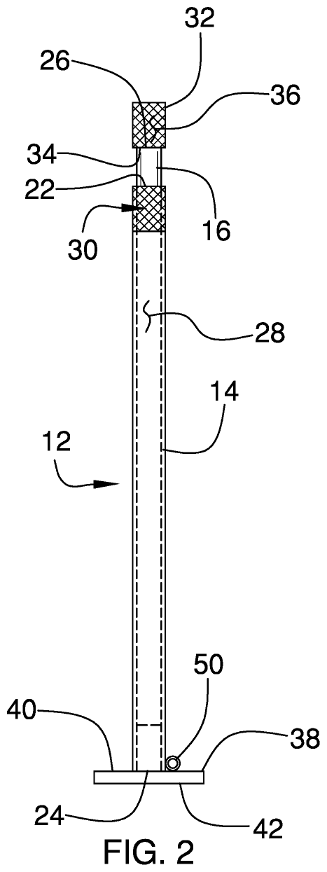

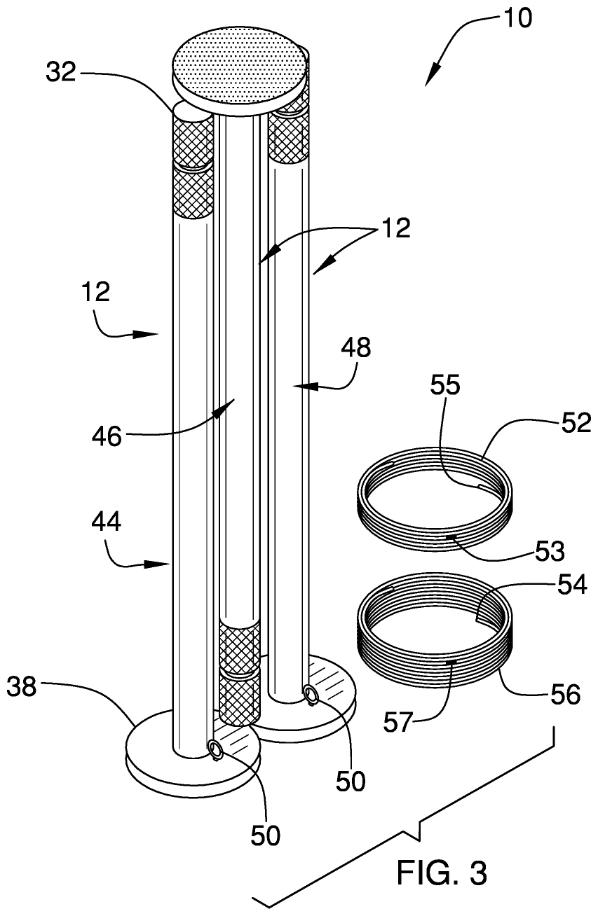

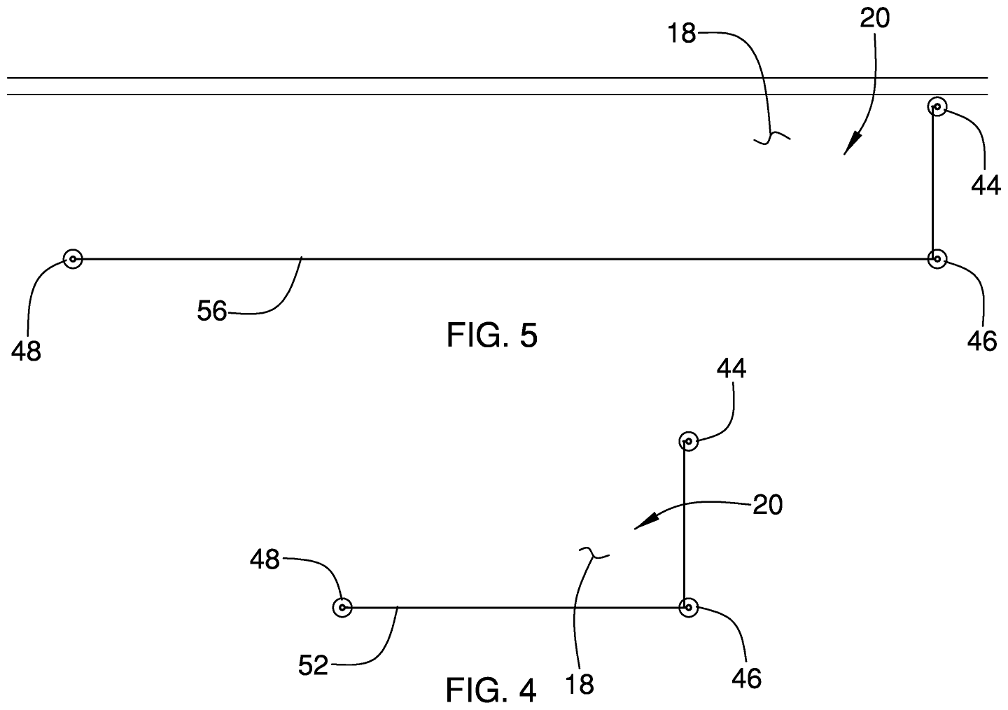

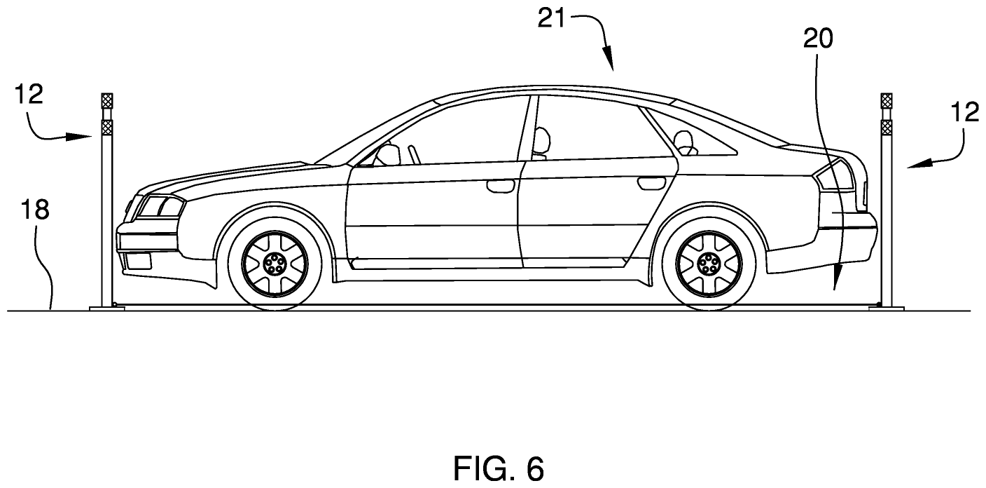

With reference now to the drawings, and in particular to FIGS. 1 through 6 thereof, a new parking device embodying the principles and concepts of an embodiment of the disclosure and generally designated by the reference numeral 10 will be described.

As best illustrated in FIGS. 1 through 6, the parking practice assembly 10 generally comprises a plurality of corner posts 12 that each comprises a first portion 14 which slidably engages a second portion 16 such that each of the corner posts 12 has a telescopically adjustable height. Additionally, each of the corner posts 12 can be strategically positioned on a driving surface 18 for defining a parking space 20 on the driving surface 18. The driving surface 18 may be a parking lot, a driveway or any other area in which a vehicle can be driven, and the vehicle 21 may be a car, a pickup or other type of motorized vehicle. The first portion 14 has an upper end 22 and a lower end 24, the upper end 22 is open, the first portion 14 is substantially hollow and the upper end 22 insertably receives the second portion 16. The second portion 16 has a distal end 26 with respect to the upper end 22 of the first portion 14.

The first portion 14 has an outside surface 28 and the outside surface 28 has a reflective portion 30 extending downwardly from the upper end 22 toward the lower end 24. The reflective portion 30 is comprised of a light reflective material to reflect light from headlights at night for enhancing visibility of the upper portion. The upper end 22 has a head 32 that is positioned thereon and the head 32 has a diameter that is greater than the diameter of the second portion 16. In this way a bottom edge 34 of the head 32 abuts the upper end 22 when the second portion 16 is fully retracted into the first portion 14. The head 32 has an outer surface 36 and the outer surface 36 comprises a light reflective material to reflect light from headlights at night for enhancing visibility of the head 32.

Each of the corner posts 12 includes a base 38 that has a top surface 40 and a bottom surface 42, and the lower end 24 of the first portion 14 is coupled to the top surface 40 of the base 38. The bottom surface 42 of the base 38 rests on the driving surface 18 having the first portion 14 and the second portion 16 being vertically oriented. A plurality of rings 50 is each coupled to a respective one of the corner posts 12. Each of the rings 50 is positioned on the top surface 40 of the base 38 and each of the rings 50 is positioned adjacent to the first portion 14 of the respective corner post 12. Additionally, the plurality of corner posts 12 includes a first corner post 44, a second corner post 46 and a third corner post 48.

A short cable 52 is attachable between the plurality of corner posts 12 and the short cable 52 has a length of at least 185.0 inches. In this way the short cable 52 can space the corner posts 12 a distance apart from each other that corresponds to the width and the length of a parking space 20 for a vehicle 21 with respect to cornerback parking. The short cable 52 has a reference mark 53 being positioned approximately 60.0 inches from a respective end 55 of the short cable 52. The short cable 52 is extendable through the ring on each of the first corner post 44, the second corner post 46 and the third corner post 48. In this way the short cable 52 is positioned close enough to the driving surface 18 to facilitate a vehicle 21 to drive over the short cable 52 without tipping over the first corner post 44 or the second corner post 46. Additionally, the ring 50 on the second corner post 46 is aligned with the reference mark 53 on the short cable 52 such that the parking space 20 has a width of approximately 60.0 inches.

A long cable 56 is attachable between second corner post 46 and the third corner post 48 such that the long cable 56 is oriented perpendicular to the short cable 52. Additionally, the long cable 56 has a length of at least 372.0 inches. In this way the long cable 56 can space the second corner post 46 and the third corner post 48 a distance apart from each other that corresponds to the length of the parking space 20 for the vehicle 21 with respect to parallel parking. The long cable 56 has a reference mark 57 being positioned approximately 60.0 inches from a respective end 59 of the long cable 56.

The long cable 56 is extendable through the ring 50 on each of the corner posts 12. In this way the long cable 56 is positioned close enough to the driving surface 18 such that the vehicle 21 can drive over the long cable 56 without tipping over the corner posts 12. Additionally, the ring 50 on the second corner post 46 is aligned with the reference mark 57 on the long cable 56 such that the parking space 20 defined by the long cable 56 has a width of approximately 60.0 inches. A plurality of fasteners, such as D-rings or other similar type of engagement, may each be coupled to a respective end of a respective one of the long cable 56 and the short cable 52 to easily attaching to the ring 50 on each of the corner posts 12.

In use, each of the first corner post 44, the second corner post 46 and the third corner post 48 are positioned on the driving surface 18 and each of the first corner post 44, the second corner post 46 and the third corner post 48 are adjusted to a desired height. The short cable 52 is extended through the ring 50 on each of the corner posts 12 to define the parking space 20 for practicing cornerback parking. The long cable 56 is extended through the ring 50 on each of the corner posts 12 to define the parking space 20 for practicing parallel parking. In each case the third corner post 48 is positioned to facilitate the long cable 56 or the short cable 52 to form a perpendicular angle. this way the long cable 56 or the short cable 52 define the parking space 20 into which the vehicle 21 can be parked for the purposes of practicing parking. Thus, a driver can practice parallel parking and cornerback parking in a closed location without the fear of striking another vehicle 21.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A parking practice assembly for practicing parallel parking and cornerback parking in a vehicle, said assembly comprising:
a plurality of corner posts, each of said corner posts comprising a first portion slidably engaging a second portion such that each of said corner posts has a telescopically adjustable height wherein each of said corner posts is configured to be strategically positioned on a driving surface for defining a parking area on the driving surface;
a plurality of rings, each of said rings being coupled to a respective one of said corner posts;
a short cable being attachable between said plurality of corner posts, said plurality of corner posts being oriented such that said short cable defines a front side and a lateral side of a parking spot, said short cable having a length of at least 185.0 inches wherein said short cable is configured to space said plurality of corner posts a distance apart from each other that corresponds to the width and the length of a parking space for a vehicle with respect to cornerback parking; and
a long cable being attachable between said plurality of corner posts such that said long cable defines a front side and a lateral side of parking spot, said long cable having a length of at least 372.0 inches wherein said long cable is configured to space said plurality of corner posts a distance apart from each other that corresponds to the width and the length of the parking space for the vehicle with respect to parallel parking.

2. The assembly according to claim 1, wherein said first portion has an upper end and a lower end, said upper end being open, said first portion being substantially hollow, said upper end insertably receiving said second portion, said second portion having a distal end with respect to said upper end of said first portion, said first portion having an outside surface, said outside surface having a reflective portion extending downwardly from said upper end toward said lower end, said reflective portion being comprised of a light reflective material wherein said reflective portion is configured to reflect light from headlights at night for enhancing visibility of said upper portion.

3. The assembly according to claim 3, wherein said upper end has a head being positioned thereon, said head having a diameter being greater than the diameter of said second portion such that a bottom edge of said head abuts said upper end when said second portion is fully retracted into said first portion, said head having an outer surface, said outer surface comprising a light reflective material wherein said head is configured to reflect light from headlights at night for enhancing visibility of said head.

4. The assembly according to claim 2, wherein:
each of said corner posts includes a base having a top surface and a bottom surface, said lower end of said first portion being coupled to said top surface of said base wherein said bottom surface of said base is configured to rest on the driving surface having said first portion and said second portion being vertically oriented; and
each of said rings is positioned on said top surface of said base, each of said rings is positioned adjacent to said first portion of said respective corner post.

5. The assembly according to claim 4, wherein said short cable being extendable through said ring on each of said first corner post, said second corner post and said third corner post wherein said short cable is configured to be positioned close enough to the driving surface to facilitate a vehicle to drive over said short cable without tipping over said first corner post, said second corner post or said third corner post.

6. The assembly according to claim 4, wherein said long cable being extendable through said ring on each of said first corner post, said second corner post and said third corner post wherein said long cable is configured to be positioned close enough the driving surface to facilitate the vehicle to drive over said long cable without tipping over said first corner post, said second corner post or said third corner post.

7. A parking practice assembly for practicing parallel parking and cornerback parking in a vehicle, said assembly comprising:
a plurality of corner posts, each of said corner posts comprising a first portion slidably engaging a second portion such that each of said corner posts has a telescopically adjustable height wherein each of said corner posts is configured to be strategically positioned on a driving surface for defining a parking area on the driving surface, said first portion having an upper end and a lower end, said upper end being open, said first portion being substantially hollow, said upper end insertably receiving said second portion, said second portion having a distal end with respect to said upper end of said first portion, said first portion having an outside surface, said outside surface having a reflective portion extending downwardly from said upper end toward said lower end, said reflective portion being comprised of a light reflective material wherein said reflective portion is configured to reflect light from headlights at night for enhancing visibility of said upper portion, said upper end having a head being positioned thereon, said head having a diameter being greater than the diameter of said second portion such that a bottom edge of said head abuts said upper end when said second portion is fully retracted into said first portion, said head having an outer surface, said outer surface comprising a light reflective material wherein said head is configured to reflect light from headlights at night for enhancing visibility of said head, each of said corner posts including a base having a top surface and a bottom surface, said lower end of said first portion being coupled to said top surface of said base wherein said bottom surface of said base is configured to rest on the driving surface having said first portion and said second portion being vertically oriented, said plurality of corner posts including a first corner post, a second corner post and a third corner post;
a plurality of rings, each of said rings being coupled to a respective one of said corner posts, each of said rings being positioned on said top surface of said base, each of said rings being positioned adjacent to said first portion of said respective corner post;
a short cable being attachable between said plurality of corner posts, said plurality of corner posts being oriented such that said short cable defines a front side and a lateral side of a parking spot, said short cable having a length of at least 185.0 inches to space said plurality of corner posts a distance apart from each other that corresponds to the width and the length of a parking space for a vehicle with respect to cornerback parking, said short cable being extendable through said ring on each of said first corner post, said second corner post and said third corner post wherein said short cable is configured to be positioned close enough to the driving surface to facilitate a vehicle to drive over said short cable without tipping over said first corner post, said second corner post or said third corner post; and
a long cable being attachable between said plurality of corner posts such that said long cable defines a front side and a lateral side of parking spot, said long cable having a length of at least 372.0 inches to space said plurality of corner posts a distance apart from each other that corresponds to the width and the length of the parking space for the vehicle with respect to parallel parking, said long cable being extendable through said ring on each of said first corner post, said second corner post and said third corner post wherein said long cable is configured to be positioned close enough the driving surface to facilitate the vehicle to drive over said long cable without tipping over said first corner post, said second corner post or said third corner post.

8. A method of practicing parking a vehicle, the steps of the method comprising:
providing a first corner post, a second corner post and a third corner post;
providing a short cable;
providing a long cable;
positioning said first corner post, said second corner post and said third corner post on a driving surface;
attaching said short cable between each of said first corner post and said second corner post thereby defining a front threshold of a parking space;
attaching said long cable between each of said second corner post and said third corner post;
positioning said third corner post such that said long cable is oriented perpendicular to said short cable thereby defining a side threshold of the parking space; and
driving a vehicle into the parking space for practicing parallel parking and cornerback parking with the vehicle.
